(19) United States
(12) Patent Application Publication
(10) Pub. No.: US 2002/0008153 A1
(43) Pub. Date: Jan. 24, 2002

(54) Instrumented firefighter's nozzle and method

(76) Inventors: John Franklin Ebersole JR., Bedford, NH (US); Todd Joseph Furlong, Goffstown, NH (US)

Correspondence Address: Mirick O'Connell DeMallie & Lougee, LLP, 100 Front Street, Suite 1700, Worcester, MA, 01608-1477, US

(21) Appl. No.: 09/826,993

(22) Filed: Apr. 5, 2001

Related U.S. Application Data
(60) Provisional application No. 60/195,503, filed on Apr. 6, 2000.

(51) Int. Cl. B05B 1/30; A62C 35/00

(52) U.S. Cl. 239/1; 239/71; 239/74; 239/539; 239/581.2

(57) ABSTRACT

Method and apparatus are presented for instrumentation of a firefighter's vari-nozzle for motion tracking and measurement of pattern selector and bail handle positions. In the embodiment presented here, brackets and associated hardware attach (1) a position tracking device to the nozzle to measure its 6-DOF (Degrees of Freedom) position and orientation, and (2) potentiometers to measure the angular positions of the two main, moving components (the bail handle and the pattern selector) of the nozzle. The mounts are attached to the brass nozzle with holes drilled into the main body of the nozzle.

One application of this instrumentation is control of an augmented reality or virtual reality water stream, or other extinguishing agent. The electronic signals from potentiometers in the instrumentation permit a computer to calculate and display graphical representations of water flow from the nozzle for virtual reality and augmented reality applications. This virtual flow is responsive to the motions of the user with the nozzle, including operation of the bail handle (on/off of water flow) and the nozzle pattern selector (straight stream, narrow angle fog, and wide angle fog). The position tracking information is used to align a computer graphical representation of a water stream with the real nozzle.

### CROSS REFERENCE TO RELATED APPLICATIONS

This application claims priority of Provisional patent application Ser. No. 60/195, 503 filed Apr. 6, 2000.

### GOVERNMENT RIGHTS

This invention was made with Government support under Contract Number N61339-98-C-0036 awarded by the Department of the Navy. The Government has certain rights in the invention.

### FIELD OF THE INVENTION

This invention relates to real-time data acquisition for purposes of measuring the operation of a fire hose nozzle. Mechanical and electronic components have been designed and attached to a nozzle for purposes of instrumentation. The field in which the invention is currently used is that of virtual reality and augmented reality. The invention is used as an input device to control a computer-generated water stream and align that stream with the actual nozzle in a manner consistent with its operation.

### COPYRIGHT INFORMATION

A portion of the disclosure of this patent document contains material that is subject to copyright protection. The copyright owner has no objection to the facsimile reproduction by anyone of the patent document or the patent disclosure as it appears in the Patent and Trademark Office records but otherwise reserves all copyright works whatsoever.

### BACKGROUND OF THE INVENTION

Information establishing the real-time position and orientation of a nozzle (e.g., a firefighter's nozzle) is useful, as is information establishing the settings of the nozzle bail handle and pattern selector. With this information, a computer will know how the nozzle is being operated, and the data may then be collected or applied to a real-time simulation. One application is the need to accurately display a graphical representation of a water stream, or other extinguishing agent, that is responsive to the actions of a user operating the nozzle, such as for augmented reality or virtual reality.

### SUMMARY OF THE INVENTION

The purpose of the invention is to enable control of a computer-generated graphical spray with a real vari-nozzle for firefighter training. Key aspects of the invention include (1) an instrumented bail handle, which controls the flow of water or extinguishing agent through a nozzle, and (2) an instrumented pattern selector, which controls the angle of the fog spray from a nozzle. Another aspect (3) of the invention is a mount that allows a motion tracker to have line of sight with the ceiling and be unobtrusive to a user of the instrumented nozzle.

The invention provides sufficient accuracy on a real-time basis so that a computer can generate realistic and responsive graphics depicting water flow through the nozzle. This flow can be a wide fog pattern, a straight stream pattern or anything in between, typical of streams used by firefighters. Additionally, the bail handle measurements provided by the instrumentation permit a computer to operate continuously from the off position to steady flow. The graphics generated by a computer can be displayed to a user of the instrumented nozzle by means of virtual reality, augmented reality, or other displays.

### BRIEF DESCRIPTION OF THE DRAWINGS

FIG. 1 is a sketch of a design for the vertical mount that holds an INTERSENSE IS-900™ “Stylus” tracking station.

FIG. 2 is an assembly drawing of the preferred vertical bracket of an IS-900™ vertical mount.

FIG. 3 is an assembly drawing and for a mount that holds an INTERSENSE IS-600™ tracking station.

FIG. 4 is a drawing of the nozzle body, with bail handle, and its dimensional relationship to the main horizontal bracket.

FIG. 5 is a mechanical drawing of the part of the nozzle spray instrumentation components that holds the potentiometer for the nozzle spray instrumentation.

FIG. 6 is a mechanical drawing of the part of the nozzle spray instrumentation components that rigidly clamps to the nozzle body with the part in FIG. 11.

FIG. 7 is a mechanical drawing of a key that attaches to a potentiometer.

FIG. 8 is a mechanical drawing of the part of the nozzle spray instrumentation components that is attached to the nozzle pattern selector and drives the key attached to a potentiometer.

FIG. 9 is an assembly drawing of the components that attach internally to the nozzle to mount a potentiometer inside the body of the nozzle, and the sensing portion of the potentiometer to the moving pattern selector.

FIG. 10 is an exploded assembly drawing of all bail handle instrumentation components.

FIG. 11 is an assembly drawing of the bail handle instrumentation components.

FIG. 12 is a wiring diagram from the analog-to-digital converter, wire/signal pairings through the twisted pair ethernet-type cable, and the anticipated connections to the two potentiometers connected to the RJ-45 connector.

FIG. 13 is a drawing of an alternative method to very simply mount the RJ-45 connector.

FIG. 14 is a drawing of an alternative method to connect a potentiometer to a bail handle.

FIG. 15 includes drawings made of alternative designs for connecting the potentiometer to the bail handle.

FIG. 16 and FIG. 17 are drawings of a design to use the linear potentiometer to sense the position of the nozzle pattern selector. In this design, the linear potentiometer is concealed inside a machined recess in the nozzle.

FIG. 18 and FIG. 19 are drawings of an alternative idea to use the linear potentiometer to sense the position of the nozzle pattern selector. In this design, the linear potentiometer does not puncture the nozzle.

### DETAILED DESCRIPTION OF THE PREFERRED EMBODIMENTS OF THE INVENTION

Most of the components that were designed and machined for this invention were made from black Delrin™ (a hard plastic made by DUPONT) (du Pont de Nemours and Company, 1007 Market Street, Wilmington, Del. 19898, U.S.A) or black Nylon 66™. The specific invention is designed to attach to a standard ELKHART (Elkhart Brass Mfg. Co. Inc., P.O. Box 1127, 1302 W. Beardsley Ave., Elkhart, Ill. 46515, U.S.A) 1.5-inch brass nozzle (Model SFL-GN-95) used for fire fighting.

Mount for the InterSense Tracking Equipment

One component of the invention is a mount for a piece of motion tracking equipment required to determine the position and orientation of the nozzle as a whole in real time. The motion tracking products used in the preferred embodiment of this invention require line of sight to ceiling-mounted grids, so the mount had to hold the motion tracking equipment to the side of and above the nozzle for best line of sight.

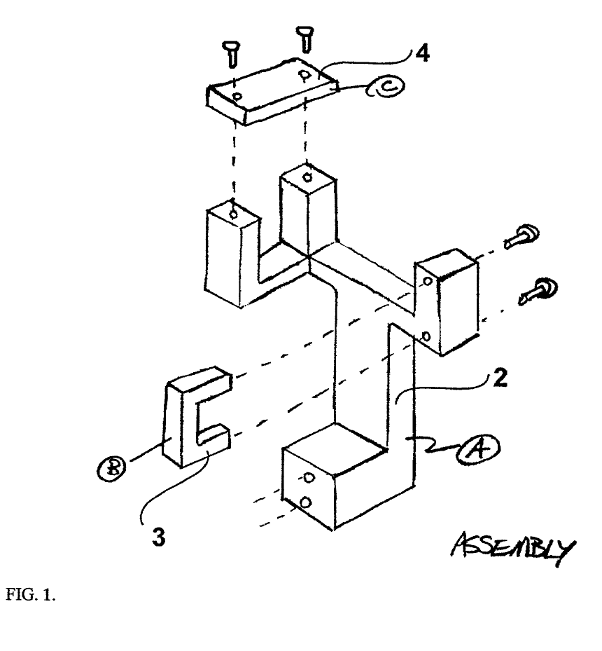

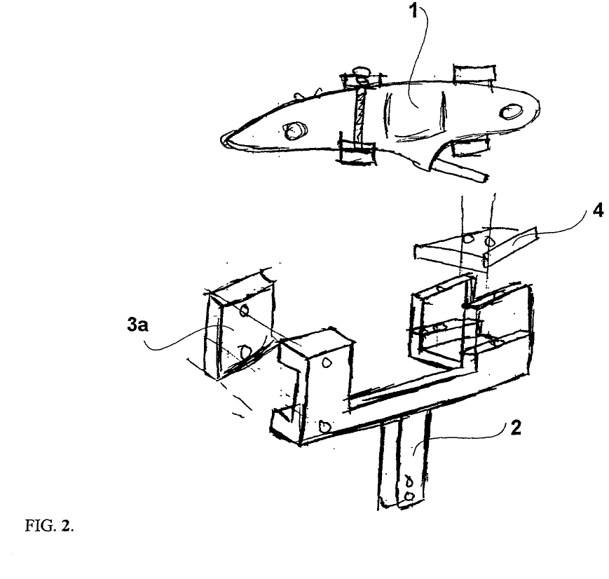

FIG. 1 is an exploded assembly drawing showing how a side clamp 3 designed to hold an INTERSENSE (InterSense, Inc., 73 Second Avenue, Burlington, Mass. 01803, U.S.A) IS-900™ stylus 1 from the side and a top clamp 4 designed to hold the stylus 1 from the top fit together with the vertical portion of the mount 2. FIG. 2 shows a sketch of the vertical portion of the mount 2 designed to hold the stylus 1 with an alternative method of attaching the stylus to the bracket via the side clamp 3a and the identical top clamp 4. The mounts we created to hold the INTERSENSE IS-900™ stylus on the side and from the top allow the stylus to be held in place firmly without having to require undue amounts of tolerance in the dimensions of the bracket components. When assembled, there are gaps between the side and top clamps which allow the screws to provide a clamping force onto the IS-900™ stylus.

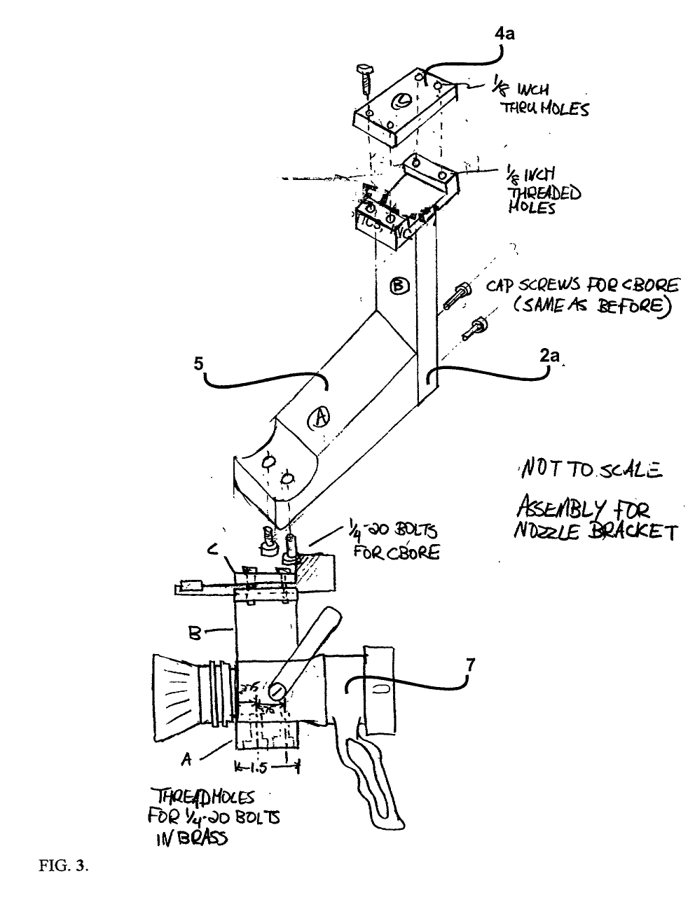

In FIG. 3, the curved cutout in the main horizontal bracket 5 matches the external radius of the nozzle. Drilling a hole (not shown) along the length of horizontal bracket 5 can produce an easy-to-wire conduit which allows wires to be contained completely within the bracket and nozzle barrel and hidden from external view. The nozzle may be drilled and tapped to match holes made in the bracket.

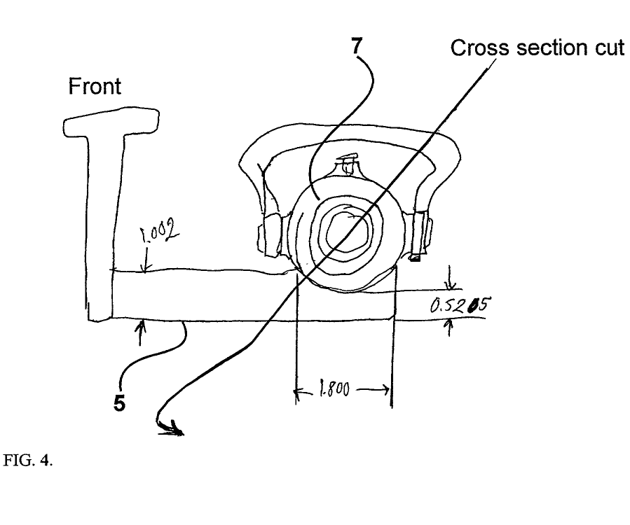

FIG. 3 also shows the INTERSENSE IS-600™ mount 2a that holds the standard IS-600™ tracking station an appropriate distance away from the nozzle so that proper tracking (no line of sight interference) and no interference with the user occurs. If interference occurs (e.g., the user is left-handed), the bracket design is reversible to allow the tracking station to be on the opposite side of the nozzle. The top cap 4a produces a clamping force on the IS-600™ tracking station to keep it in place. FIG. 3 shows an isometric view of how the components 5, 2a, and 4a fit together and attach to the nozzle 7. FIG. 4 shows a front view of the nozzle 7 and bracket 5 assembly.

Mount for Potentiometer to Measure the Pattern Selector Position

The nozzle pattern selector rotates approximately 180 degrees counter-clockwise relative to the nozzle sleeve, and it is used to set the angle of the nozzle spray pattern. The nozzle sleeve clicks solidly into place relative to the nozzle body, but it can be undone for a “flush” setting, and can rotate about 150 degrees clockwise relative to the nozzle body. Together, this adds up to about 330 degrees of total motion. However, only 180 degrees of it needs to be supported for normal operations (straight stream, narrow angle fog, and wide angle fog). The “flush” setting is not anticipated to be an important training factor, and the nozzle sleeve is required to remain locked for the potentiometer to properly read the pattern selector's position. Requiring the sleeve to be locked allows the design to be simpler.

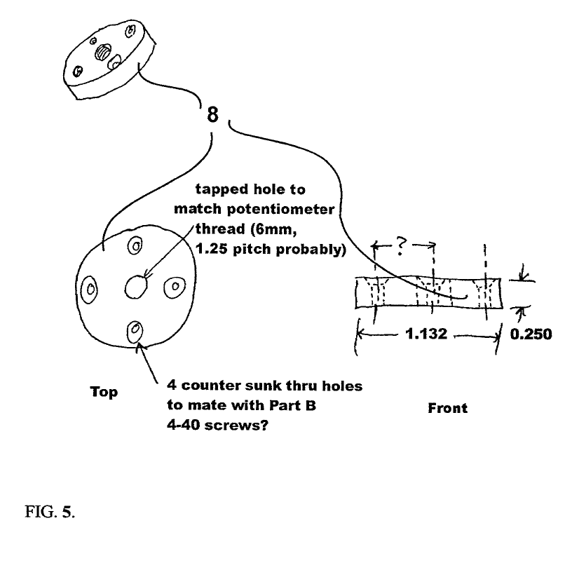

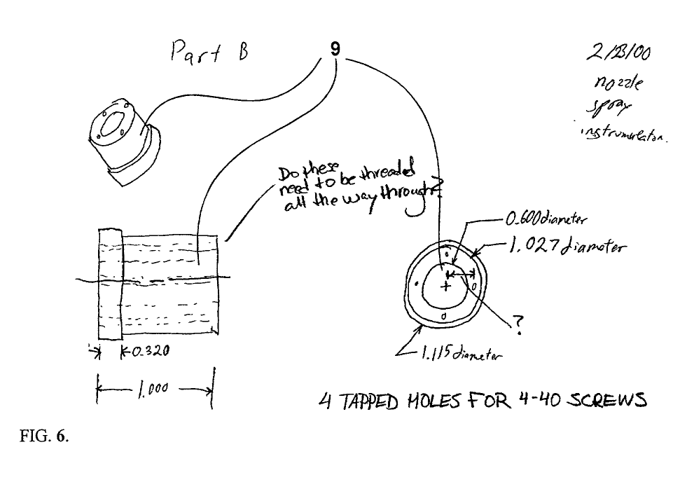

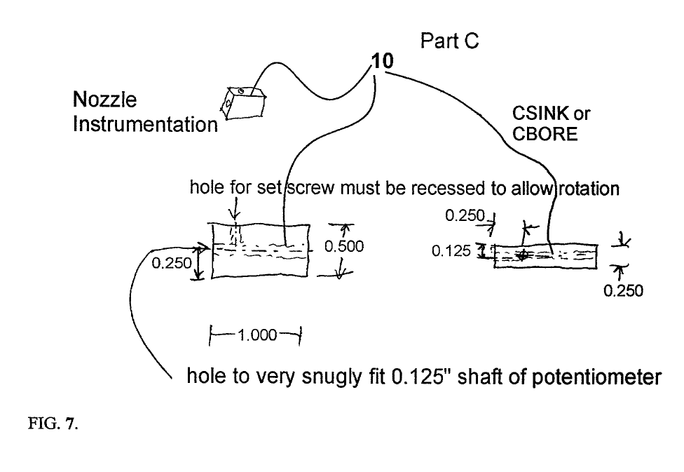

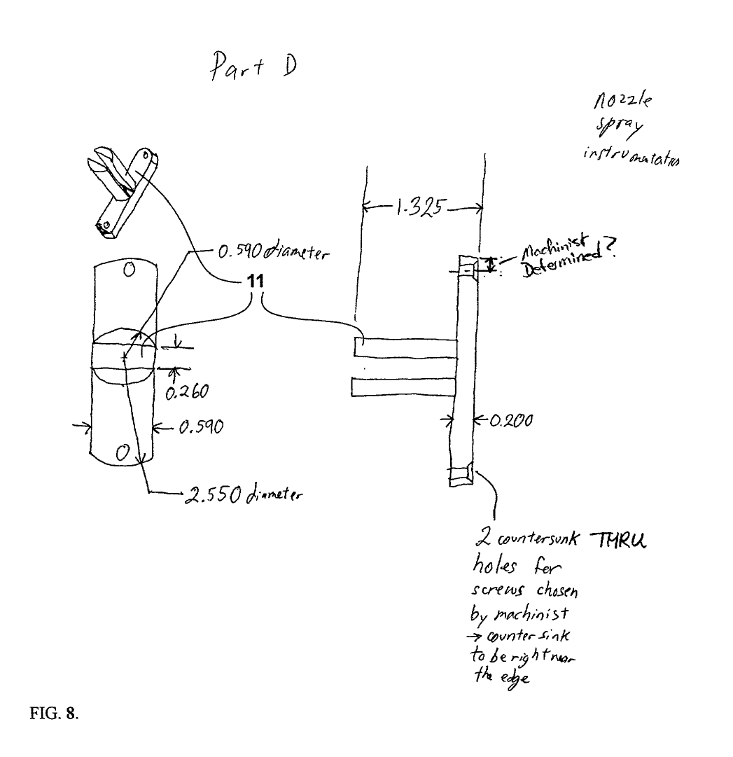

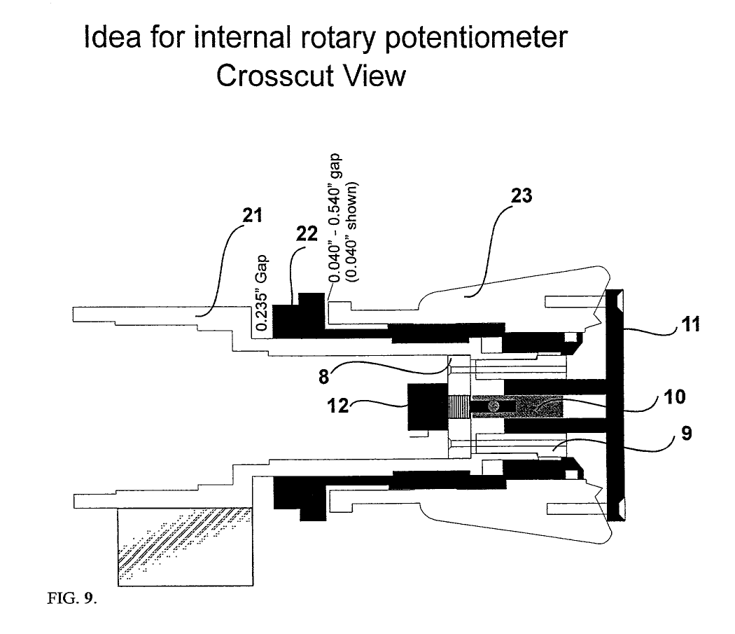

FIG. 5 shows a plate 8 that mates to cylinder 9 in FIG. 6. FIG. 7 shows a key 10 that attaches to a potentiometer shaft, and FIG. 8 shows a part 11 with a slot that fits over the key 10 and rotates the potentiometer shaft. FIG. 9 shows an assembly drawing of these parts, illustrating how they rotate the shaft of the potentiometer 12 in concert with the pattern selector 23 to measure the rotation of the pattern selector 23. Pieces 8 and 9 fit inside the nozzle barrel 21 and remain fixed in place by clamping down on a shelf inside nozzle barrel. There is a gap between the two pieces to allow the screws to generate a clamping force. Potentiometer 12 screws into plate 8, and the rotating portion of the potentiometer protrudes into the cylinder 9. Part 11 screws into the rubber portion of the pattern selector 23, fits over key 10, and rotates the shaft of potentiometer 12 when the pattern selector is turned.

The potentiometer 12 has a range of rotation of only 295 degrees. Therefore, even though 10 has a place for a setscrew, it was not used in the preferred embodiment because it would damage the part if the user ever turned the nozzle sleeve. It was noticed that the key held very tightly to the shaft of the potentiometer, and the friction between the shaft and key was sufficient in measuring the motion of the pattern selector 23 without slipping.

Mount for Potentiometer to Measure the Bail Handle Position

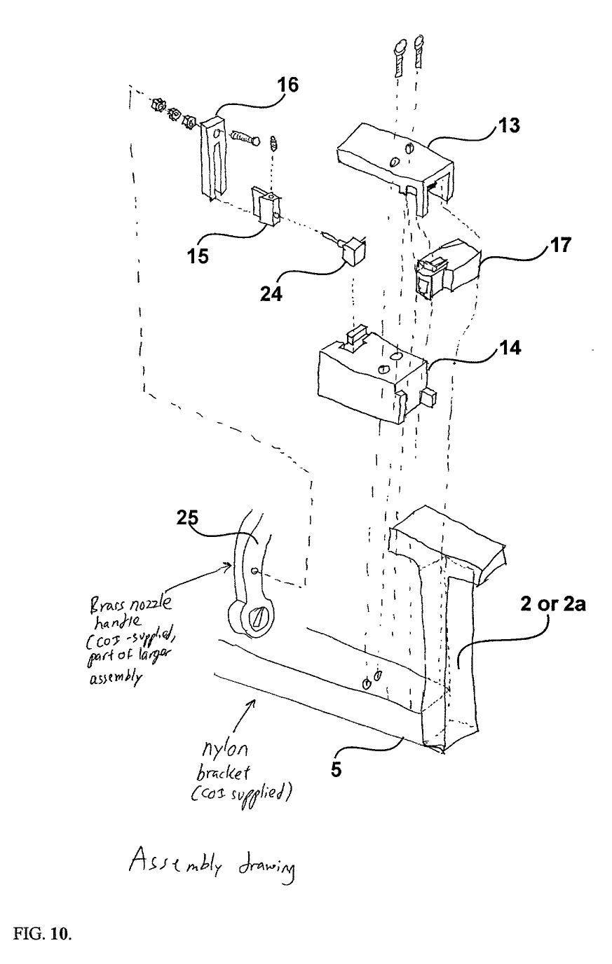

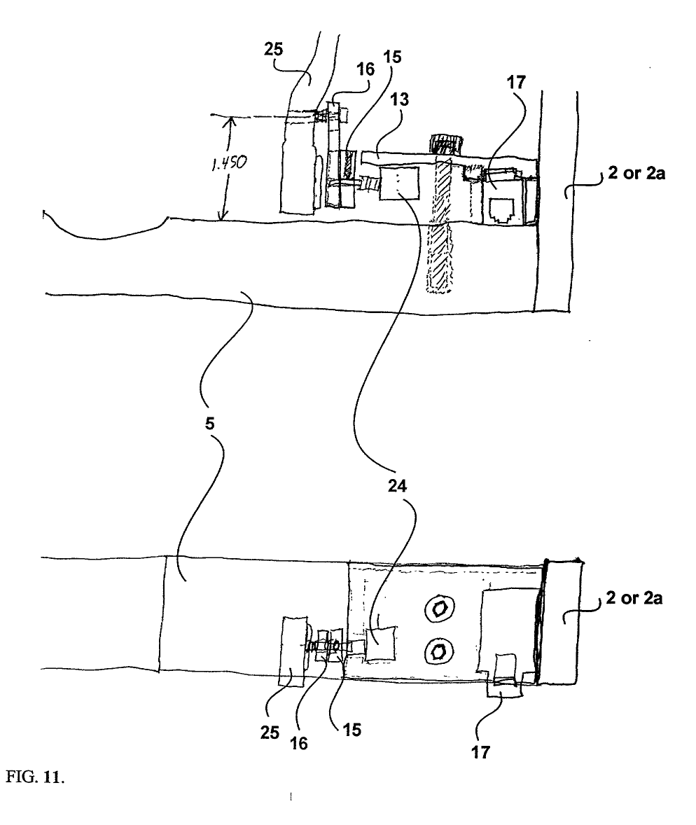

The nozzle bail handle (25 in FIG. 10) rotates approximately 100 degrees, and the shaft of the potentiometer (the same model as chosen for the nozzle pattern selector) is designed to rotate about the same axis as the bail handle. Part 13 and part 14 in FIG. 10 form a case that holds a potentiometer 24 and RJ-45 connector 17 and attaches to the main horizontal bracket 5. Potentiometer 24 rigidly attaches to key 15, which fits into keyway 16. Keyway 16 is attached to bail handle 25 with a bolt into a tapped hole in 25. Washers or nuts may be used for spacing the keyway 16 away from the bail handle 25. FIG. 11 shows front and top views of the assembly from FIG. 10.

Even though the potentiometer is designed to be centered, a key 15 and keyway 16 in FIG. 10 were designed to allow for a great deal of misalignment of the parts, thereby reducing the risk of damaging the sensitive potentiometer. The key 15 fits in the keyway 16 with a tight, yet sliding fit, allowing movement in all 6 degrees of freedom to compensate for a lack of perfect machining and part placement, and to allow for some slop in the axis of rotation of the nozzle bail handle. A gap between the body of the key 15 and the keyway 16 was introduced so that axial motion (along the potentiometer shaft) in either direction won't damage the potentiometer. The net effect is that the potentiometer is rigidly mounted, but the coupling effectively connects the motion of the bail handle to the shaft of the potentiometer with essentially no play and without putting any significant stress on the bearings of the potentiometer.

An 8-pin RJ-45 connector 17 in FIG. 10 is held on five sides by parts 13 and 14. The INTERSENSE bracket vertical mount 2 or 2a and the main horizontal mount 5 combine to hold the RJ-45 connector on the remaining side. The bottom surface of the connector was ground flat to make it sit better. The RJ-45 connector and an associated 8-pin category 5 network cable were used because they could easily be obtained in black.

Electrical and Analog-to-Digital Aspects of the Invention

Because only four signals are needed, LLGND (low level ground), +10 V (for power), AI0 (Analog In 0), and AI1 (Analog In 1), a four-pin telephone (RJ-11 cable) system could have been used instead of an RJ-45 cable. The components for such a system are known to exist, but since 8-pin components were readily available, those were used. A similar design using four-pin telephone connections is considered for use in future revisions of the invention.

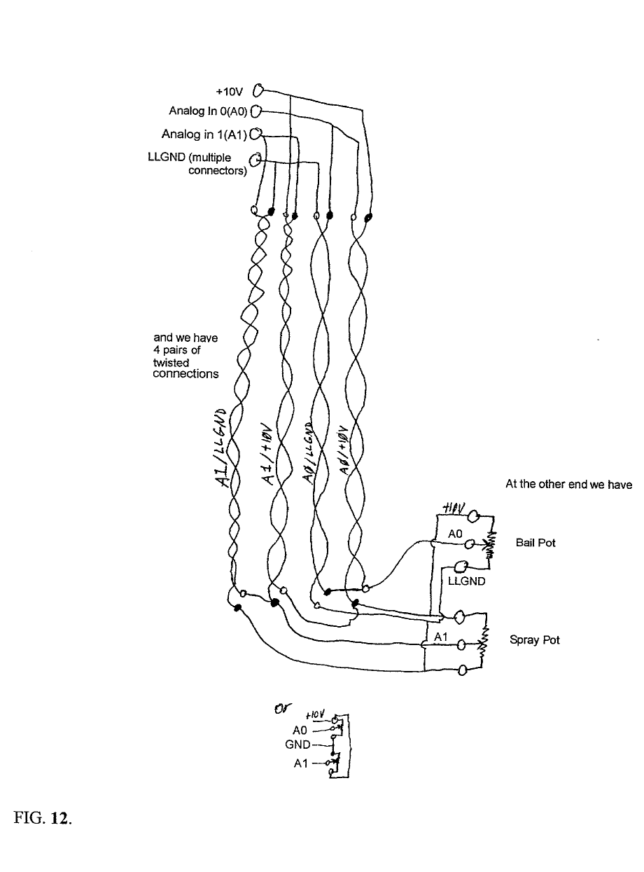

In making the connection from the analog-to-digital converter, there were four signals to deal with (ground, +10 volts, and the two readings from the potentiometers, signal 0 and signal 1), and 8 wires to accomplish the task. To make the best use of the wires, using the fact that a twisted-pair cable has pairs of wires twisted together to reduce electromagnetic noise and interference, a wiring pattern was chosen (FIG. 12) which made logical pairings between the signal connections and power/ground wires.

There are two main types of wiring layouts of RJ-45 connectors. Both were used in the invention. One RJ-45 connector is attached to a box made to connect to an analog-to-digital converter, and one is attached to the nozzle bracket.

Potentiometers 12 and 24 (Model #93F9870, Spectrol Electronics Corp., 4051 Greystone Drive, Ontario, Calif. 91761, U.S.A) were chosen based on a few factors: (1) small size, (2) square shape to allow easy mounting, (3) range of motion, and (4) resistance value. The resistance value of ten kilo-ohms was chosen because the ten volt power supply on the analog-to-digital converter can supply two milliamps. The closer the load is set to the maximum current load, the better, since lower resistances produce less noise. With the two potentiometers, the load is two milliamps.

The analog-to-digital converter we chose for our implementation, the COMPUTERBOARDS PPIO-8™, (Measurement Computing Corp., formerly ComputerBoards, 16 Commerce Boulevard, Middleboro, Mass. 02346, U.S.A) is an inexpensive parallel port-based unit. It takes power from the PC, and sends its information to the PC via the parallel port. A software development kit is available which allows input from the unit to be used in applications written in a number of programming languages.

Alternate Embodiments of the Invention

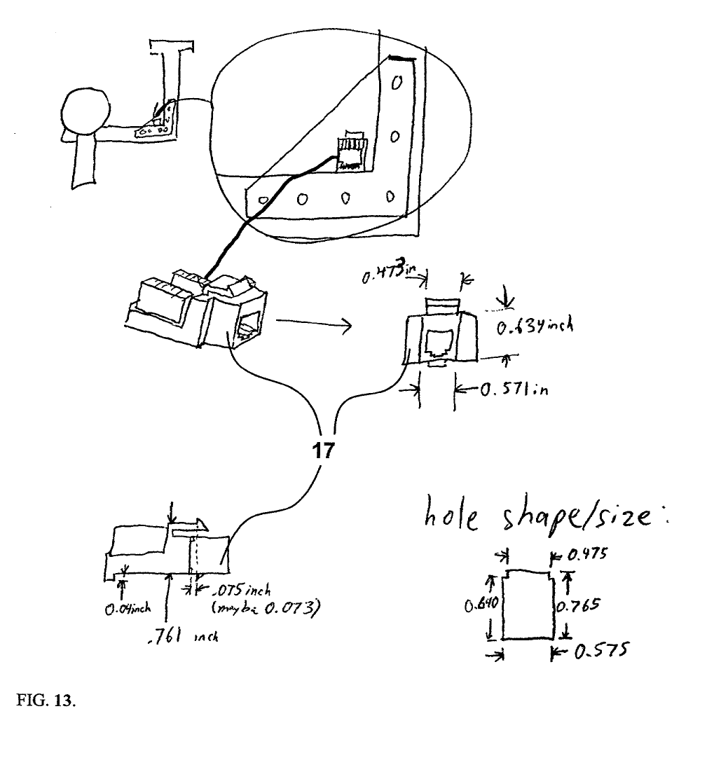

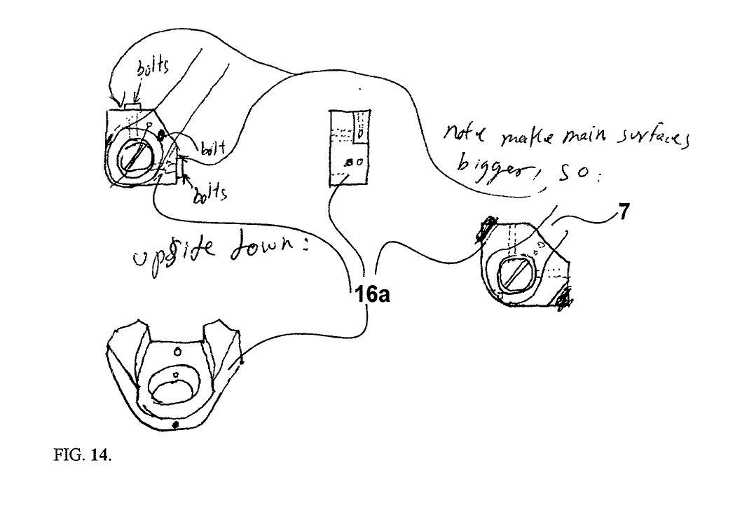

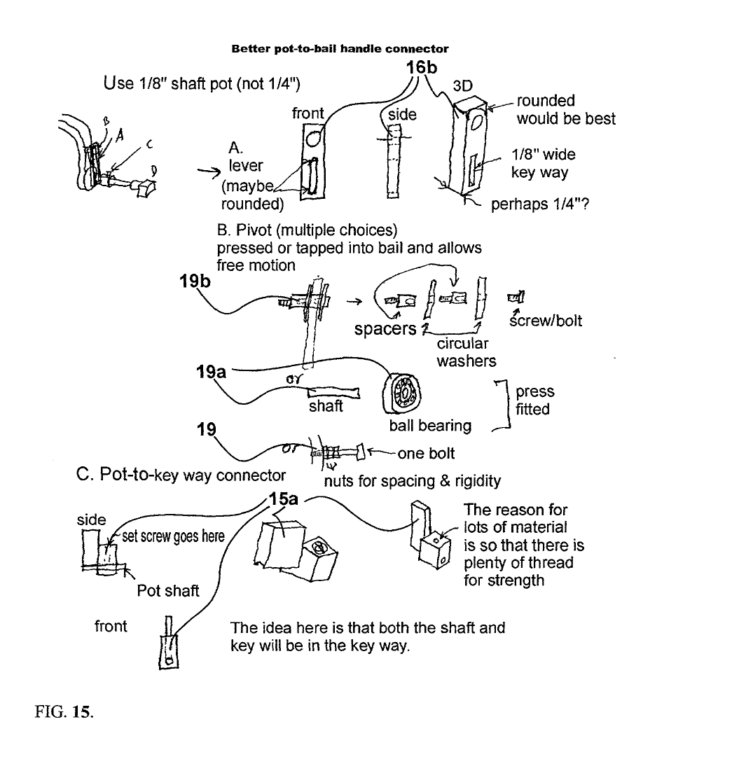

Several methods were considered before arriving at the preferred embodiment, and those methods are presented in the remaining Figures. FIG. 13 shows an alternate method of mounting the RJ-45 connector 12 with a single mounting plate. This design is simpler to make and install than the preferred embodiment, but is less durable, so it was not chosen for this implementation. FIG. 14 shows an alternative part 16a that could be used for a nondestructive or destructive coupling of potentiometer 24 to bail handle 25. Whether the design in FIG. 14 is nondestructive or destructive depends on whether the screws penetrate the bail handle or simply clamp onto it. FIG. 15 shows an alternate embodiment of a keyway 16b with a closed bottom. Additionally, FIG. 15 shows three methods of attaching keyway 16 or 16b to the bail handle 25, including bolt and nuts 19 (the preferred embodiment), press-fit bearing and shaft 19a, and pivot 19b. FIG. 15 also shows an alternate potentiometer-to-keyway connector 15a.

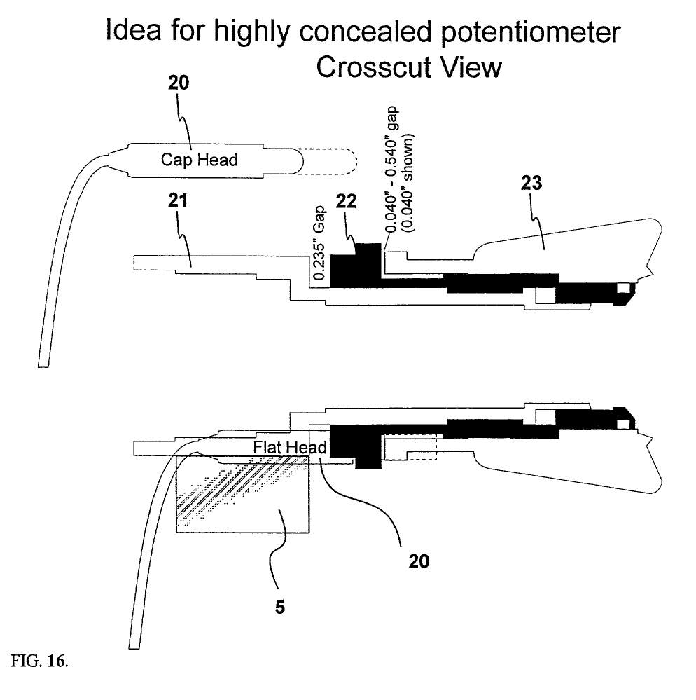

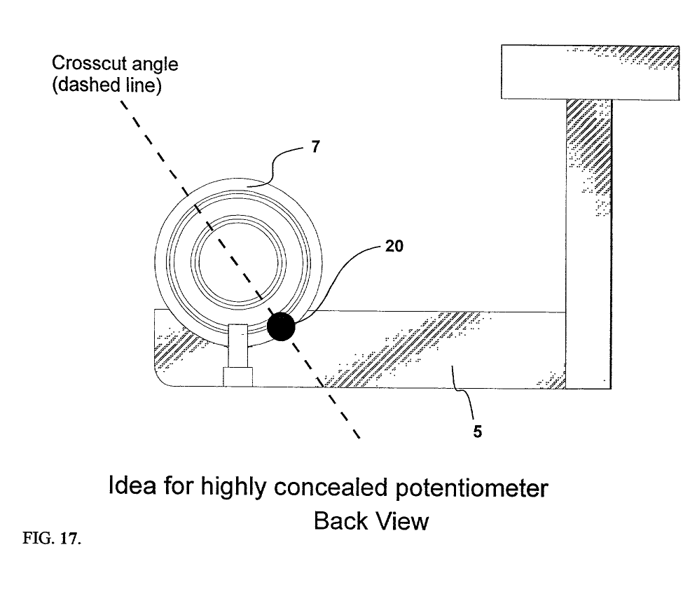

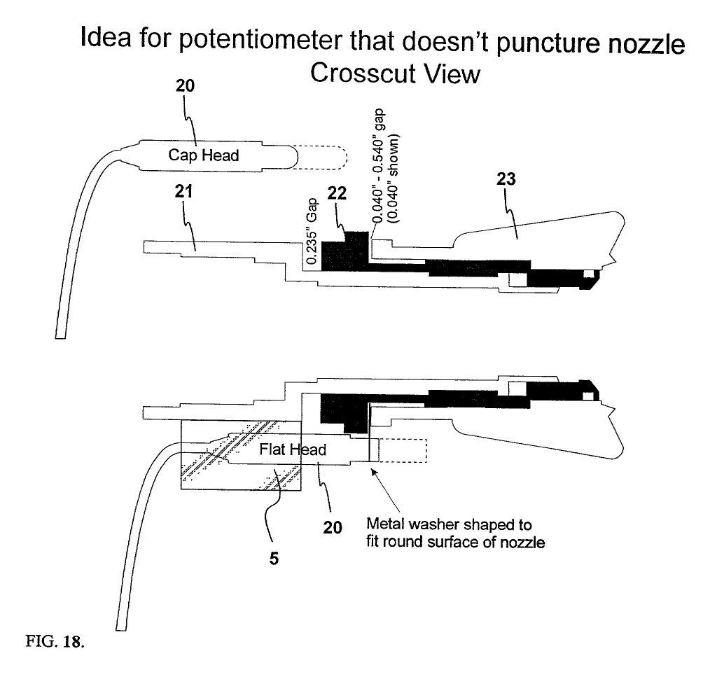

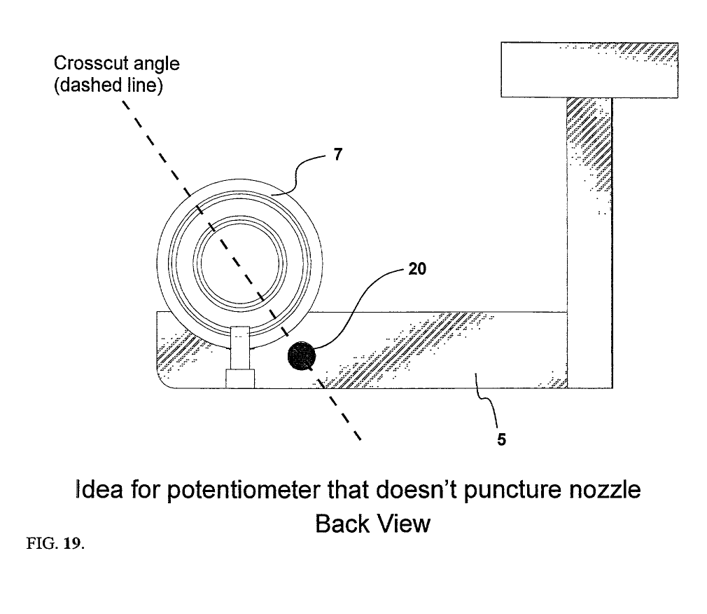

A spring-loaded linear potentiometer 20 in FIG. 16 has also been considered to measure pattern selector angle instead of rotational potentiometer 12. FIG. 16 illustrates that a cap head or flat head linear potentiometer can fit into a hole drilled in the nozzle body 21 and 22. The potentiometer 20 can be compressed as the pattern selector 23 is turned. FIG. 17 presents another view of this alternative. FIG. 18 and FIG. 19 illustrate an alternate mounting location for potentiometer 20 that does not require a hole to be drilled in 21 and 22.

Although specific features of the invention are shown in the drawing and not others, this is for convenience only, as each feature may be combined with any or all of the other features in accordance with the invention.

Other embodiments that will occur to those skilled in the art are within the following claims:

What is claimed is:

1. An instrumented firefighter's nozzle that determines the settings of the nozzle's pattern selector and bail handle settings, comprising:
a firefighter's nozzle with a pattern selector and a bail handle; and
sensors for measuring the settings of the pattern selector and the bail handle.

2. The firefighter's nozzle of claim 1 in which one or more of the sensors are potentiometers.

3. The firefighter's nozzle of claim 1 further including a protective enclosure for the sensors and wiring to increase ruggedness.

4. The firefighter's nozzle of claim 1 further including an RJ-45 connector and standard 8-wire cable and an analog-to-digital converter, wherein the connector and cable are used to transmit the electrical signals from the sensors to the analog-to-digital converter.

5. The firefighter's nozzle of claim 1 further including an analog-to-digital converter and a standard RJ-11 telephone-type wire and connectors, wherein the wire and connectors are used to transmit the electrical signals from the sensors to the analog-to-digital converter.

6. The firefighter's nozzle of claim 2 further including a key and keyway for attaching the potentiometer to the nozzle bail handle.

7. The firefighter's nozzle of claim 1 in which a linear potentiometer is used to measure the position of the nozzle pattern selector.

8. A method for tracking the position of a firefighter nozzle to determine its location in a space in real time, comprising:
attaching a main bracket to a nozzle; and
attaching additional, exchangeable brackets to the main bracket which may hold one of several different kinds of tracking stations, both custom and commercial-off-the-shelf.

9. The method of claim 8 in which a standard InterSense IS-600™ tracking station may be rigidly mounted and used.

10. The method of claim 8 in which a standard InterSense IS-900™ Stylus tracking station may be rigidly mounted and used.

11. The firefighter's nozzle of claim 1 in which the brackets are further modified to support the attachment of tracking stations without reducing the functionality of the sensors that measure the positions of the pattern selector and bail handle.

12. The firefighter's nozzle of claim 1 in which the sensors and associated brackets are designed in such a way at to be largely non-intrusive to the user and resistant to damage by the user.

13. The firefighter's nozzle of claim 1 in which the wires connecting the sensors to the analog-to-digital converter run inside a standard firefighter nozzle hose.
